(19) United States
(12) Patent Application Publication
(10) Pub. No.: US 2003/0047825 A1
(43) Pub. Date: Mar. 13, 2003

(54) Method and apparatus for producing an optimally reinforced structural component

(76) Inventors: Carl H. Visconti, Clarkston, MI (US); Edward J. Wenzel, Tory, MI (US)

Correspondence Address: Kathryn A. Marra, ESQ., Delphi Technologies, Inc., Legal Staff, P.O. Box 5052, Troy, MI, 48007-5052, US

(21) Appl. No.: 09/950,481

(22) Filed: Sep. 10, 2001

(51) Int. Cl. B29C 43/02; B29C 43/36; B29C 43/58

(52) U.S. Cl. 264/40.1; 264/308; 264/320; 264/323

(57) ABSTRACT

A method of making a reinforced component by depositing a polymer into an extrusion deposition unit, during the plastication process a reinforcing material is deposited into the extrusion deposition unit. The amount and type of fiber is varied in order to provide a molded component with varying degrees of reinforcement and/or strength. The extrudate having a varying fiber reinforcement is deposited onto a mold core or cavity.

### CROSS REFERENCE TO RELATED APPLICATIONS

This application is related to U.S. patent application Ser. Nos. 09/268,198 filed on Mar. 11, 1999, and Ser. No. 09/695,652 filed Oct. 24, 2000, the contents of which are incorporated herein by reference thereto.

### BACKGROUND

Vehicles have various interior body parts, which present an aesthetically appealing appearance as well as a functional utility. The interior body parts may include door trim panels, instrumentation panels, ceiling panels, and structural components including cross-car beams and other support members. These panels serve to dampen sound, provide structural support, and absorb kinetic energy for the protection of passengers.

The makeup of these panels typically includes multiple components arranged in substrates or layers of varying shapes and materials. An external component material usually has an aesthetic appearance and the internal component material serves to provide physical utilitarian functions as stated above. Some of the components are made with fiber reinforced thermoplastics.

The production of fiber reinforced thermoplastic components results in molded products with a fairly consistent distribution of fibers. The consistent distribution of fibers throughout the component results in having fiber reinforcement in areas that do not require reinforcement. The generalized consistent distribution of fiber reinforcement results in fiber reinforcement in areas that require different fiber reinforcement. The reinforcement requirements of various areas within the components may vary depending on the function of the particular area of the components.

Fiber reinforcement processes that produce a generalized consistent distribution of fiber reinforcement can result in a component that has reinforcement materials located where not beneficial and/or in excess of what is required in some areas. The generalized distribution process of fiber reinforcement in molding technology can result in waste and unnecessary cost.

### SUMMARY OF THE INVENTION

A reinforced component is capable of being manufactured so that the panel is aesthetically appealing and functional for use in vehicles. The process to make the reinforced component can also be less costly and performed with optimum usage of materials. Polymer and reinforcing fiber materials are combined in an extrusion deposition compression molding unit. The amount or concentration of fiber materials is varied within the extrusion deposition unit, allowing for varying reinforcing fiber distribution across the component when the extrudate is deposited into a mold cavity.

The present invention utilizes the molding characteristics of an extrusion deposit compression molding process (EDCM), also known as extrusion compression molding, melt compression molding, or back compression molding, to mold an item.

EDCM is an open mold process, and this feature allows for the use of specific processing techniques to combine different polymer materials and/or inserts within the same tool or mold cavity.

The EDCM apparatus also includes a compression mold which is comprised of first and second mold dies which mate with one another so as to mold an item. The apparatus is manipulated so that the extrusion die head is passed over the mold to thereby deposit material into predetermined areas of the mold cavity.

In addition, the open mold process allows the extrusion deposition unit to pass over the mold area regardless of its shape. Thus, the unit deposits the required molten material within the mold thereby reducing the required amount of flow of material to fill all of the cavities of the mold.

The mold is closed and the deposited material within the mold cavity fills out the mold cavity under pressure and the mold is opened after the required cooling time. The resultant molded article includes the different materials that mold the item.

The EDCM process provides a manufacturing cost reduction that is realized due to optimal material usage. Optimal material usage is accomplished by one or more of the following alternatives: (1) a lower cost material may be used for any specific area of the part due to the application of optimum reinforcement material and placement and use of the optimum material for each function and (2) the ability to mold thinner sections across the component as may be justified by structural analysis, and (3) the present invention provides the ability to vary the amount of reinforcing material across the component as required by the function of the specific area. Additional cost savings are achieved through lower cost tooling and reduced tonnage equipment.

The EDCM process requires lower pressures as compared to other molding processes and accordingly results in a reduction in the tonnage of force and machinery required by the process. In addition, the EDCM process allows the use of more complex molds. Therefore, the molded item will have fewer attached parts as they can be molded directly. By eliminating or using fewer attached parts, there is reduced opportunity for squeaks and rattles and other quality deficiencies to occur.

The above described and other features and advantages of the present invention will be appreciated and understood by those skilled in the art from the following detailed description, drawings, and claims.

### BRIEF DESCRIPTION OF THE DRAWINGS

The present invention will now be described, by way of example only, with reference to the accompanying drawings wherein:

FIG. 1 is a perspective view of a molding apparatus used in an exemplary embodiment of the present invention;

FIG. 2 is a simplified side view of an extrusion/deposition unit for use in the apparatus of FIG. 1;

FIG. 3 is a top plan view of an exemplary molding apparatus for use in the manufacturing disclosed herein;

FIG. 4 is a top plan view of a mold portion for use with the molding apparatus of FIGS. 1-3;

FIG. 5 is a side view of a molding apparatus used in an exemplary embodiment of the present invention;

FIG. 6 is a side view of a molding apparatus used in an exemplary embodiment of the present invention; and

FIG. 7 is a perspective view illustrating high stress areas of a molded component; and

FIG. 8 is a perspective view of a molded component.

### DESCRIPTION OF THE PREFERRED EMBODIMENT

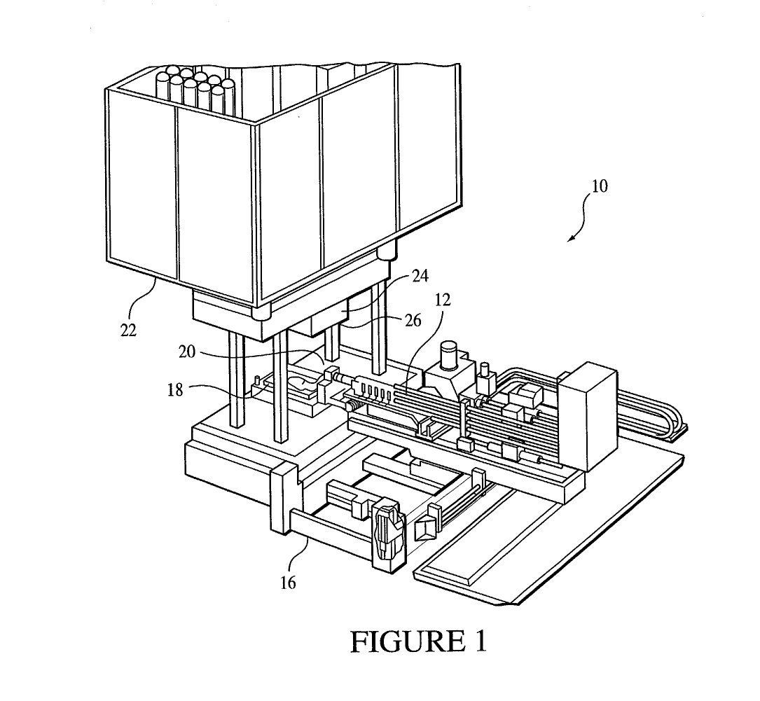

Referring to FIGS. 1-4 an extrusion deposition compression molding (EDCM) apparatus 10 is shown. The exemplary molding apparatus 10 is used with a molding process or such extrusion deposit compression molding (EDCM), or extrusion compression molding, or melt compression molding, or back compression molding, or compression molding of molten thermoplastic materials. The apparatus has an extrusion/deposition unit 12 mounted on a positioner 16. The positioner is preferably a programmable X-Y-Z positioner.

Positioner 16 relocates or moves the extrusion/deposition units so that a melted polymer may be disposed across a first mold cavity 18 of a mold 20. The first mold cavity 18 embodies a portion of the shape of the item to be molded.

Molten thermoplastic is disposed into the first mold cavity 18 from the extrusion/deposition unit until the required amount of material is deposited within the first mold cavity 18. The first mold cavity is positioned and secured onto the lower platen of a press 22. Press 22 has a deployable member 24, also known as the upper platen, on which is positioned and secured a second mold cavity 26. Second mold cavity 26 is a complementary to first mold cavity 18. Accordingly, and after the molten thermoplastic is deposited within the first mold cavity 18, the press lowers the second mold cavity 26 over the first mold cavity causing the deposited thermoplastic material flow and to be molded by the first and second mold cavities. It is also noted that first mold cavity 18 and second mold cavity 26 are removable so that other mold cavities can be appropriately placed to mold other objects.

In an exemplary embodiment, press 22 is a hydraulic press, however, other presses capable of lowering the second mold cavity over the first with the required amount of force are also contemplated to be within the scope of the present invention.

Press 22 exerts a force on the second mold cavity 26 which makes contact with the exposed surface of the molten thermoplastic as well as provides a boundary for the molten thermoplastic to take form and cool or set after being deposited or disposed in the first mold cavity 18.

In addition, press 22 will maintain the pressure on the materials that are being molded (typically molten thermoplastic) as the materials cool and shrink or set. Thus, there will be no deformations in the item being molded due to shrinkage or settling within the mold. This can be accomplished through the use of a thermister or other temperature measuring device to determine when the molded part has reached the proper temperature for demolding, or it can be accomplished by waiting the proper amount of time prior to demolding. In addition, or as an alternative, a pressure gauge can be positioned to measure the pressure between first mold cavity 18 and second mold cavity 26. Thus, the information from the thermister or pressure gauge or both can be supplied to a controller which will maintain or possibly increase the pressure being applied by press 22.

For example, the molten thermoplastic is generally in an expanded state when compared to its cooled or cured temperature. Thus, press 22 must apply a greater force when the molten thermoplastic is in the mold. In addition, and when the material cools, the press will have to lower the second mold cavity in order to maintain contact with the curing material.

Accordingly, a more uniform shape in the item being molded is maintained by having a continuous pressure force applied by the press 22. By pressing and following the materials in the mold cavity as they contract, the press 22 also eliminates stresses and defects that may result from the shrinkage of the molten thermoplastic.

As an alternative to lowering the second mold cavity and maintaining the pressure on the cooling thermoplastic materials, the second cavity may be stopped using stop blocks at a specified component thickness. This is done when the thermoplastic material includes a blowing or foaming agent or when one of the inserted non-molten materials is compressed during the lowering of the second mold cavity, but it also can be done using only thermoplastic materials that have minimal shrink or that otherwise do not result in problems due to shrinkage.

As a further alternative, the second mold cavity 26, after being lowered onto the first mold cavity 18, can be lifted away from the melted thermoplastic a minimal amount and lowered again, and this can be done several times during the cycle of molding a part.

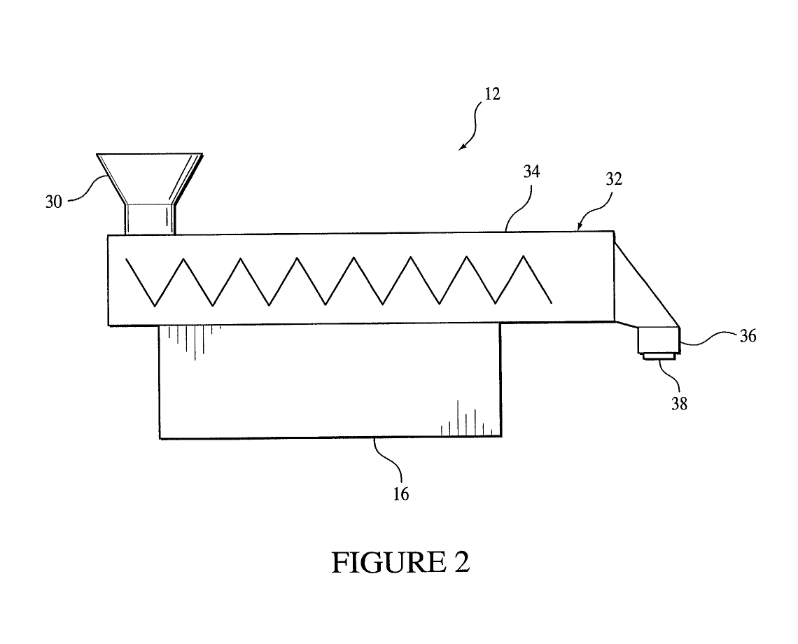

Referring now to FIG. 2, an extrusion/deposition unit 12 is shown. In an exemplary embodiment, two extrusion/deposition units are mounted on the positioner. Of course, additional extrusion/deposition units may be used depending on the number of different materials needed to mold the item. The velocity of the movement of the extrusion/deposition unit can vary the quantity of molten thermoplastic or molten polymer deposited. The extrusion/deposition unit can also vary the quantity of molten polymer by the rate of injection.

The extrusion/deposition unit 12 has a feed element 30. Feed element 30 provides an opening for receiving a polymer to be heated and deposited by the extrusion/deposition unit. Typically the polymer is in pelletized form and is melted by a heating element disposed within the unit and by the shear force provided within the plastication unit 32. As an alternative, a separate extruder could be used to feed melted thermoplastic into the extrusion/deposition unit, and this extruder could be fed by plastic pellets and/or fiber materials.

The extrusion/deposition unit has a plastication/injection unit 32 configured to receive the materials from feed element 30. Plastication/injection unit 32 has a plurality of internal components within a barrel portion 34. The plurality of internal components include but are not limited to the following: a screw or screws for receiving the pelletized polymers and additional fibers for reinforcement, the screws mix and arrange and apply shear forces to the pelletized polymer; a plurality of heating bands for heating and melting the pelletized polymer and a hydraulic piston/ram for forcing the screw forward and thereby forcing the molten polymer out of an extrusion die opening 36. The amount of distance that the hydraulic piston and screw move forward determines the overall amount of melted thermoplastic deposited onto the mold cavity, and the speed of the hydraulic piston/screw movement determines the flow rate of the material. The size to die opening will also affect the shape of the molten polymers.

The extrusion die opening can be configured to have a fixed opening of most any shape. For example, the fixed opening may be a circle, rectangle, triangle, star etc. Alternatively, a slidable member 38 with a plurality of variable openings can be positioned to provide alternative openings for each issue die opening 36.

The extrusion/deposition unit conveys the molten plastic materials to the extrusion die opening and can provide a means for metering the amount of molten polymer out of the extrusion die opening and accordingly onto the mold cavity. In addition, the amount of molten polymer that is deposited within the mold cavity may be varied by the overall amount of movement of the hydraulic ram. The localized amount of material deposited can be varied by the speed of the hydraulic ram and positioner.

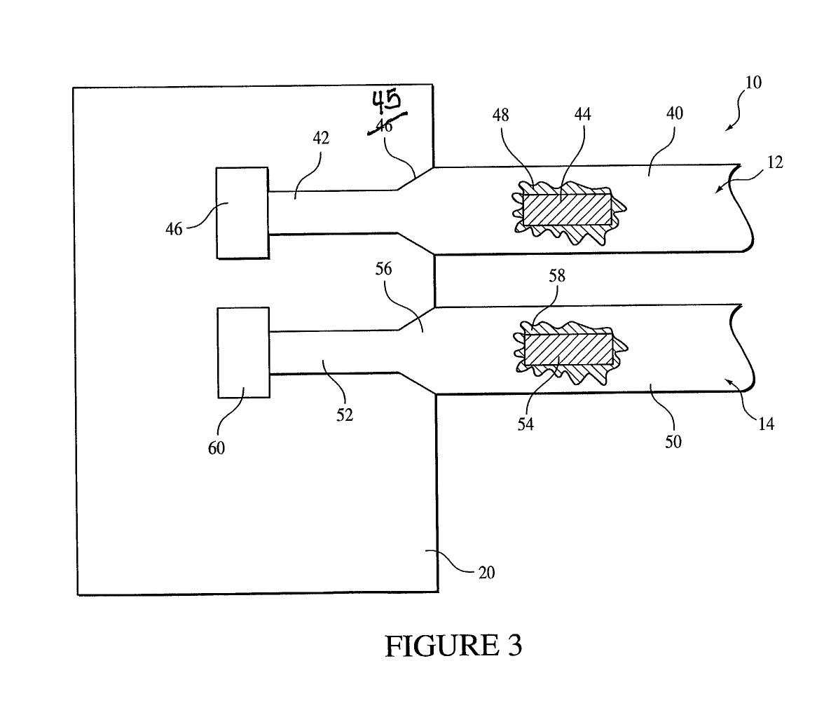

Referring now to FIG. 3, portions of apparatus 10 are shown. Here, the apparatus broadly comprises an extrusion compression molding apparatus (or EDCM or back compression molding) according to one embodiment of the present invention, the apparatus comprises a first extrusion/deposition unit 12 and a second extrusion/deposition unit 14.

An alternative type of extrusion/deposition unit 12 and 14 can consist of a cylindrical plunger with a similar extrusion die. This plunger unit can be fed molten plastic material, with or without fiber reinforcement or other additives, from a separate extruder. Plastic pellets and/or fiber materials are fed into the extruder. By moving the ram of the plunger forward, melted thermoplastic can be forced out of the extrusion die, and the amount of movement and the speed of the movement can be used to control the amount of material and flow rate as required.

As another alternative method to an apparatus that includes two extrusion/deposition units that deposit the molten plastic onto the first mold cavity, one or both of the extrusion/deposition units can deposit or extrude a specific volume of material onto a conveyor or other platform, and this deposited/extruded material can then be transferred using a robot or other method of automated transfer to the first mold cavity.

The first extrusion/deposition unit 12 includes a barrel section 40 having an inlet section (not shown) and an opposing outlet section 42. The barrel section 40 contains an injection/plastication screw, partially indicated at 44, which longitudinally extends the length of the barrel section 40. The illustrated first extrusion/deposition unit 12 further has a neck section 45 that is formed between the barrel section 40 and the outlet section 42. The injection/plastication screw 44 is rotatably mounted within the barrel section 40 and is designed to advance polymeric material through the barrel section 40 at elevated temperatures and under pressure that causes the polymeric material to become a polymer melt.

Typically, the injection/plastication screw 44 has a number of flights which are usually wrapped in a helical manner around the body of the injection/plastication screw. The polymeric material is generally introduced into the first extrusion/deposition unit 12 in a solid form, such as plastic pellets, and then the rotational movement of the injection/plastication screw 44 and the flights causes the polymeric material to be conveyed within the barrel section 40 toward the outlet section 42 and through a heated compacted environment where the material is heated under carefully controlled conditions to melt the polymeric material (to form a melt 48) and the material is mixed to a reasonably uniform temperature while the melt is pressurized and pumped forward toward the outlet section 42.

A first extrusion die 46 is connected to the outlet section 42 and includes a die channel (not shown) included therein. The die channel fluidly communicates with the outlet section 42 so that the melt advances through the outlet section 42 and into the die channel. One end of the die channel thus comprises a deposit opening in which the melt (extrudate) is discharged through. The first extrusion die 46 and more specifically, the die channel may have any number of shapes so that the stream of extrudate which exits the first extrusion/deposition unit 12 has a desired shape. The first extrusion die 46 is not always the same dimension. The first extrusion die 46 may change in order to match the varying composition across the part (e.g., larger openings for larger mold areas).

It will be appreciated that a reinforcing material may be added to the melt at any number of locations along the first extrusion/deposition unit 12 so as to form a fiber-reinforced extrudate. Alternatively, the reinforcing fiber may be already in the plastic pellets. This is particularly advantageous when it is desired to further enhance or alter the material and/or performance characteristics of the extrudate.

As will be described in greater detail hereinafter, certain portions of the resultant molded structure produced by the present process require different material characteristics than other portions of the structure. For example, the manufacture of one portion may require additional fiber reinforcement because it is desired to increase the structural properties of this one portion of the structure. It is within the scope of the present invention that any number of suitable fibers (e.g. glass, natural etc.) may be used as the reinforcing material. While it may be possible to manufacture the entire article out of a single material, this may not always be the most optimal, cost effective method. The use of the material with the highest reinforcement across the entire article, for example can result in reinforcement where it is not required and special design considerations where more energy absorption is required.

In the illustrated embodiment, the second extrusion/deposition unit 14 is similar to the first extrusion/deposition unit 12 and is spaced apart therefrom. It will be appreciated that the second extrusion/deposition unit 14 does not necessarily have to be identical or similar to the first extrusion/deposition unit 12 so long as both the first and second extrusion/deposition units 12, 14 are intended for use in an extrusion deposit compression molding process.

According to the present invention, the first and second extrusion/deposition units 12, 14 are each designed to move in the x, y, and z directions so that each of the first and second extrusion/deposition units 12, 14 may be properly positioned relative to a first mold die which is generally indicated at 18. The designations of x, y, and z are typical of any three-axis movement, with x being into and out of the press space, y being lateral movement with respect to the x axis, and z being vertical with respect to the x axis. In a simplified version of this invention, the first and second extrusion/deposition units 12, 14 can be designed to move only the in x direction or only in the x and z directions or x and y directions. For simplicity, the first mold die 18 is not shown in detail and FIG. 3 is intended to convey the spatial relationship between the first mold die 18 and the first and second extrusion/deposition units 12, 14. The first and second extrusion/deposition units may be connected to one another so that movement of one causes the simultaneous movement of the other or each of the first and second extrusion/deposition units 12, 14 may move independent from the other.

The second extrusion/deposition unit 14 is similar to unit 12 in that it includes a barrel section 50 having an inlet section (not shown) and an opposing outlet section 52. The barrel section 50 contains an injection/plastication screw, partially indicated at 54. The illustrated second extrusion/deposition unit 14 further has a neck section 56 formed between the barrel section 50 and the outlet section 52. The injection/plastication screw 54 is rotatably mounted within the barrel section 50 and is designed to advance polymeric material through the barrel section 50 at elevated temperatures and under pressure which causes the polymeric material to become a polymer melt generally indicated at 58. Typically, the injection/plastication screw 50 has a number of flights which are usually wrapped in a helical manner around the body of the injection/plastication screw.

A second extrusion die 60 is connected to the outlet section 52 and includes a second die channel (not shown) formed therein. The second die channel fluidly communicates with the outlet section 52 so that the melt advances through the outlet section 52 and into the second die channel. One end of the second die channel thus comprises a deposit opening in which the melt (extrudate) is discharged through. The second extrusion die 60 and more specifically, the second die channel, may have any number of shapes so that the stream of extrudate which exits the second extrusion/deposition unit 14 has a desired shape. It will be appreciated that a reinforcing material may be added to the melt at any number of locations along the second extrusion/deposition unit 14 including in the pellets so as to form a fiber-reinforced extrudate.

Because the molding apparatus 10 includes first and second extrusion/deposition units 12, 14 each having a separate extrusion/deposition head, namely first and second extrusion dies 46, 60, respectively, each extrusion/deposition unit 12, 14 may contain a different polymer material used to form the extrudate and furthermore the type and/or amount of reinforcing fiber may be varied between the first and second extrusion/deposition units 12, 14. There may be two different materials in the same mold die 18.

Thus according to the present invention, the first extrusion/deposition unit 12 may be used to deposit a first extrudate in the mold die 18 and the second extrusion/deposition unit 14 may be used to deposit a second extrudate in the mold die 18. This results in the ability of the operator to tailor the construction of the resultant molded article. In the exemplary embodiment of the invention described in detail later, only one of the two extrusion/deposition units can be utilized to mold a part with the advantages and benefits that are the result of the invention.

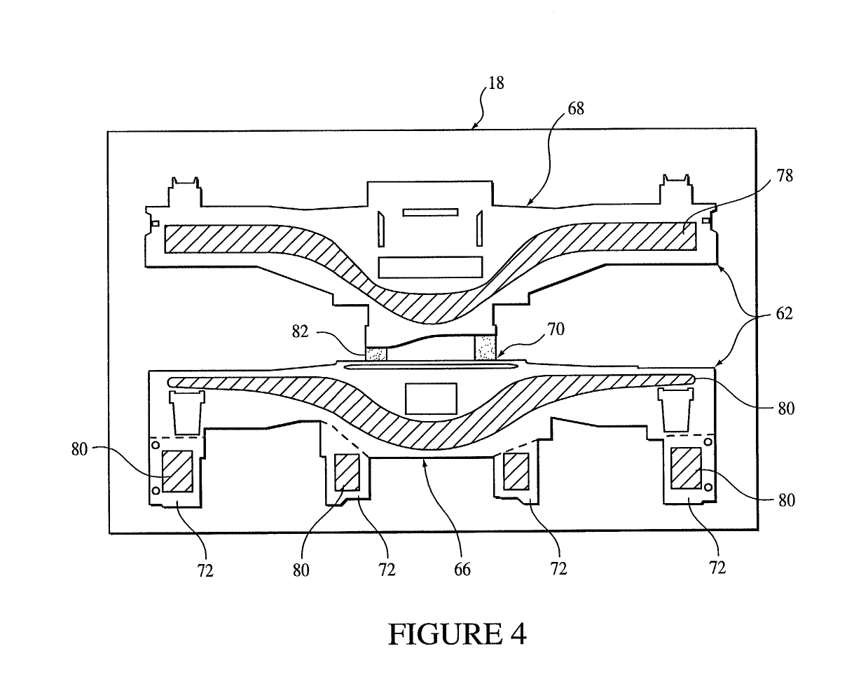

Referring now to FIGS. 3 and 4. FIG. 4 is a top plan view of one configuration of first mold die 18. In a compression molding process, the mold is formed of two complementary parts, namely the first mold die 18 and a second mold die (not shown) which mates with the first mold die 18 under compressive forces so as to fill-out the first and second molds with the extrudate. In an extrusion deposit compression molding process, the extrudate is deposited onto the first mold die 18 and then the first and second mold dies are closed and compressed under pressure.

Referring now to FIG. 4, the first mold die 18 shown in FIG. 4 includes a cavity, generally indicated at 62, for receiving one or more extrudates from the first and second extrusion/deposition units 12, 14. The cavity 62 generally has the shape of the resultant molded article so that compression of the first and second mold dies under pressure results in the molded article being formed. Of course, the process disclosed herein may form any item of any configuration.

The cavity 62 actually is formed of a first section 66 and a second section 68 with a hinge section 70 being formed therebetween. For some designs, the cavity 62 may actually be molded of three separate sections. In addition, these sections could actually be individual mold cavities mounted together in one press or in separate presses. More specifically, the first section 66 is formed of a recessed section of the first mold die 18. The hinge section 70 comprises one or more recessed portions of the first mold die 18 which link the first section 66 with the second section 68 and thus these recessed portions comprise hinge sections.

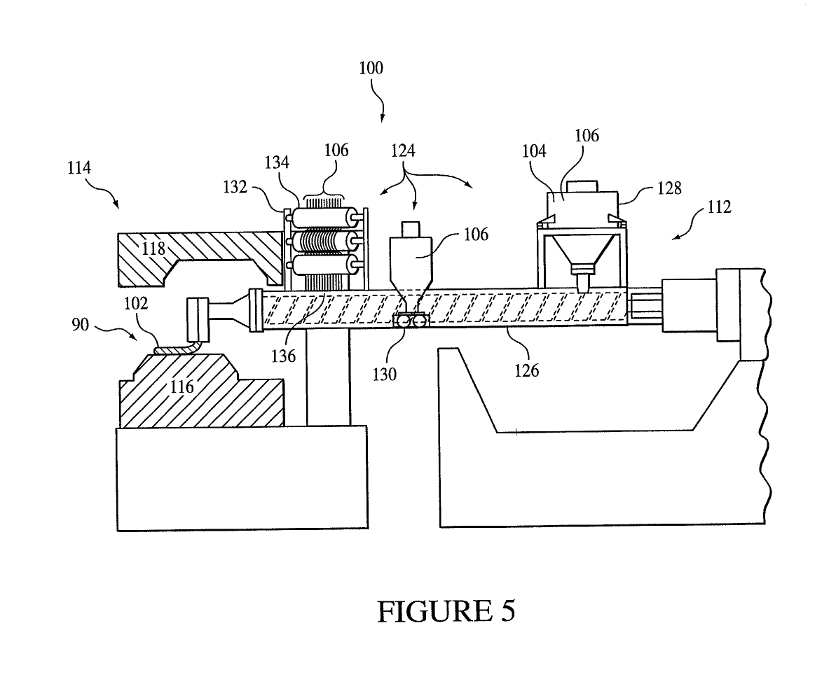

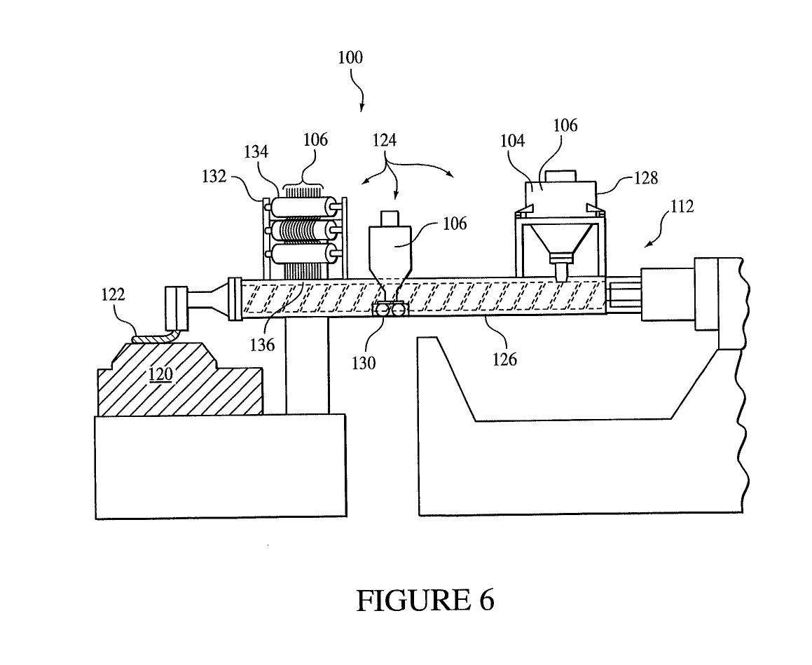

In an exemplary embodiment a process for manufacturing a component 90 having varying fiber reinforcement across its dimensions will now be described with reference to FIGS. 4, 5 and 6. The process of molding the component 90 with varying reinforcement using the equipment referenced above and/or the equipment shown in FIGS. 5 and 6, involves several steps. These steps can be simultaneous or non-simultaneous. In general, a molding apparatus 100 is set up to process the component 90 from an extrudate 102 disposed into a mold tool 114. An extrusion deposition unit 112 provides the extrudate 102 and deposits the extrudate 102 onto a first mold cavity 116. A second mold cavity 118 is pressed onto the extrudate 102. The first mold cavity 116 can also be referred to as the first mold die, and the second mold cavity 118 can be referred to as the second mold die. In addition, the mold cavities 116 and 118 can also be referred to as the mold cavity and the mold core, with the mold cavity normally molding the front side of the component and the mold core normally molding the back side of the component.

In another embodiment, extrudate 102 can be deposited onto a conveyor 120 or other transfer device (not shown) making generally an extrudate log 122 that is transferred to the first mold cavity 116 by conventional mechanical methods or simply extrudate 102 formed by the process.

The process of producing a component 90 with varying reinforcement across its dimensions can be further described as shown at FIGS. 5 and 6. The molding apparatus 100 is equipped with feed element(s) 124. As described above the feed elements 124 provide openings for receiving a polymer material 104 to be heated and deposited by the extrusion/deposition unit 112. The polymer material 104 can be fed through the hopper like feed element(s) 124. A fiber reinforcement 106 can also be feed into the plastication/injection unit 126 of the extrusion deposition unit 112 through the feed elements 124. The fiber reinforcement 106 can be chopped fibers, strand fibers, or a blend of strand fibers such as a mesh (not shown). As mentioned above, the polymer can be in a form of pellets that can have fiber reinforcement 106 blended into the pellets as well. The polymer material 104 and the fiber reinforcement 106 are mixed and processed in the extrusion deposition unit 112 through the plastication/injection unit 126 to form the extrudate 102 or the extrudate log 122.

The feed elements 124 may vary in form and specific function. The pellitized polymer can be fed through a gravity feeder 128 also known as a gravimetric dosing unit. The gravity feeder 128 can feed raw pellets at various rates and times into the plastication/injection unit 126. The chopped fiber reinforcement can be fed through a side stuffer 130. The side stuffer 130 can process chopped fiber and deposit it into the plastication/injection unit 126 at varying rates and times. Strand fiber reinforcement can be fed through a roving fiber feeder 132. The roving fiber feeder 132 can have preheat rolls 134 to preheat the strand fiber before being disposed in the plastication/injection unit 126. The roving fiber feeder 132 can input strand fiber 138 into the plastication/injection unit 126 at a roving intake zone 136.

The operation of the molding apparatus 100 and process of varying reinforcement across a component's dimensions can be described further with reference to FIGS. 5 and 6. In general, producing a component with a varied composition of reinforcement can be performed with the molding apparatus 100. Varying the quantity of fiber disposed into the extrudate, (i.e., varying percent by weight of the fiber), can alter the reinforcement. Varying the material make-up of the fiber, (varying the length of the fiber), can change the reinforcement. Varying the type of fiber can also alter the reinforcement across the dimensions of the component. Any combination of the above mentioned variables are also employed to vary the reinforcement.

The process of varying the reinforcement for the fiber reinforced thermoplastic has similar aspects as the above described process of making a molded article. The extrusion deposition unit 112 is fed with polymer material 104 in varying quantities through the gravity feeder 128. The polymer is heated and transported through the plastication/injection unit 126 where chopped fiber is disposed at various times during plastication of the polymer inside the plastication/injection unit 126 at the side stuffer 130. The chopped fiber can be varied by percent weight depending on the amount of reinforcement desired. A quantity of strand fiber can also be disposed into the polymer melt by the roving fiber feeder 132 through the roving intake zone 136. The strand fiber can be deposited by percent weight at various times during plastication. The extrudate 102 that is deposited by the extrusion deposition unit 112 will posses a varying quantity and/or quality of fiber reinforcement.

The fiber reinforcement in the extrudate 102 can be varied by the time at which the various fibers are input into the molten polymer as the polymer is processed through the extrusion deposition unit 112 and disposed into the mold cavity 116. It is contemplated that multiple feed elements 124 of different varieties can be employed to process a fiber reinforced thermoplastic component. The multiple feed elements 124 can be located at multiple locations along the plastication/injection unit 126.

The use of multiple passes over the mold cavity 116 can also be employed to vary the layering and subsequently vary the reinforcement of the component 90. Multiple passes are contemplated for also varying the orientations of the fibers in each successive layer. The introduction of more or different fibers can be employed in the melt to coincide with depositing the extrudate 102 over a thin portion in the mold cavity 116 where the component 90 will have need for greater structural integrity. The use of a combination of the multiple pass and fiber reinforcement variation can create a component of varying reinforcement without unnecessary waste.

By utilizing the process of varying the reinforcement of the thermoplastic component, an extrudate 102 (into a mold by layers) or an extrudate log 122 (onto a conveyor like mover) having varying reinforcement along the length of the extrudate 102 or along the extrudate log 122 can be produced. The fiber reinforcement can be varied by percent weight along the length of the extrudate 102 or extrudate log 122. To vary the fiber reinforcement by percent weight, the amount of fiber fed into the plastication/injection unit 126 is increased or decreased during plastication and concurrently decreasing or increasing the amount of a matrix polymer fed into the plastication/injection unit 126. The fiber length and type of fiber contained within the extrudate 102 or the extrudate log 122 can be varied. Varying the fiber length and/or content can be done by varying the use of multiple feeder elements 124 incorporated along the length of the plastication/injection unit 126. The various feeder elements 124 can be actuated at various time intervals during plastication to obtain the desired properties along the length of the extrudate 102 or the extrudate log 122.

In accordance with an exemplary embodiment, the preferred length of the fibers is 0.5 inches to 3.0 inches. The preferred fiber length is provided as an example and the method of the present invention is not intended to be limited by the same. The fiber length depends, in part, on the item being molded and the required strength as well as the stresses encountered.

In some applications, and where applicable, it is possible to use a continuous fiber length.

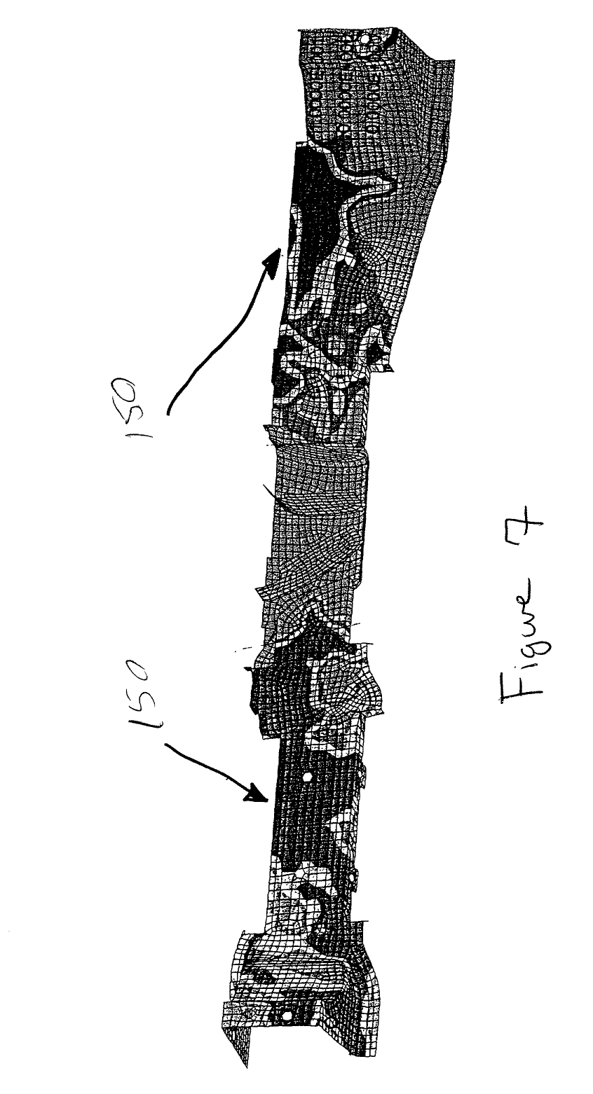

FIG. 7 illustrates a molded article where areas of high stresses are identified using modeling techniques. For example, the item in FIG. 7 has been determined to have higher stress loading areas 150 identified by the darker shaded areas in FIG. 7. Accordingly, the item in FIG. 7 will require greater reinforcement in the high stress areas. This is achieved by providing higher fiber concentration in those areas during the molding process. Similarly, lower stress areas (e.g. lighter shaded areas) require lower fiber concentrations.

Accordingly, and in accordance with an alternative embodiment of the present invention, stress modeling techniques are employed to determine specific reinforcement locations and requirements for a particular item. Thus, a prearranged reinforcing pattern is available for a particular article. This pattern is capable of being inputted into a control algorithm for controlling the feeders, the plastication units and the x, y and z positioner etc. as the item is being molded.

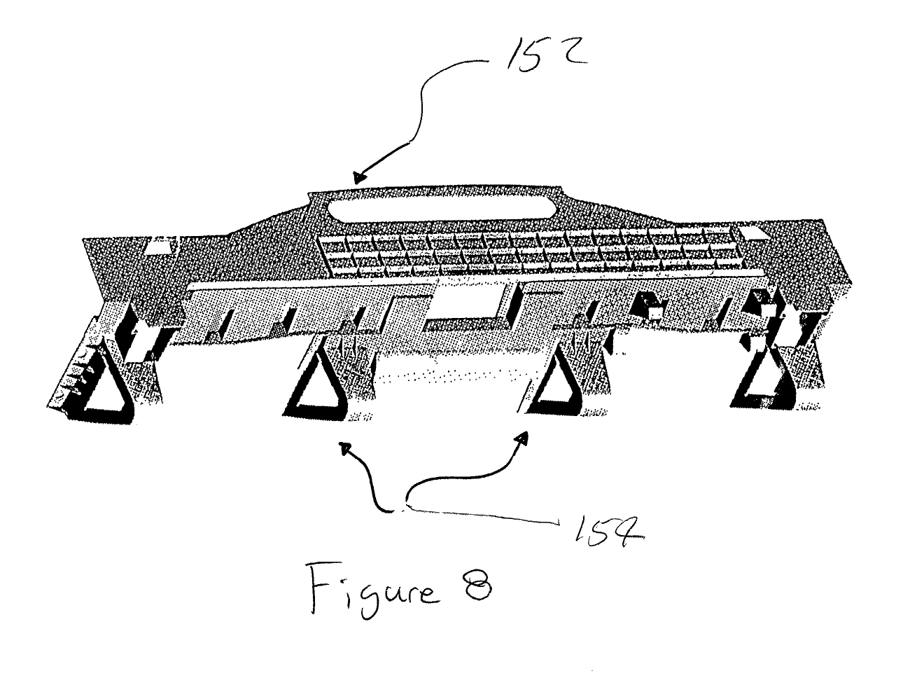

FIG. 8 illustrates a molded article having at least two different strength requirements which can be achieved by varying the size, percent and type of materials being used. For example and for purposes of illustration, area 152 requires high stiffness with potential for variable reinforcement across the surface. Areas 154 require high elongation, lower stiffness and lower fiber content. Accordingly, the article in FIG. 8 is capable of being molded in accordance with an exemplary embodiment of the present invention. Different reinforcement materials are provided by the multiple feed elements. The reinforcement materials are provided either simultaneously all or at different times.

In accordance with an exemplary embodiment of the present invention, extrusion deposition compression molding is used to produce a component that has varying reinforcement across its dimensions. This is achieved by varying the weight of fiber, the length of the fiber and/or varying the type of fiber.

In accordance with an exemplary embodiment of the present invention a “log” is produced or the extrudate is deposited directly onto the mold half with varying reinforcement along the log or extrudate.

The fiber percent by weight can be varied alone the length of the “log” or extrudate by increasing or decreasing the amount of fiber fed into the extruder during the plastication and concurrently decreasing the amount a matrix polymer said into the same extruder.

The fiber length and fiber type contained within the “log” or extrudate can be varied via the use of multiple feed/stuffer mechanisms incorporated along the extruder barrel length. The specific feeder/stuffer is/are actuated at various times during the plastication to obtain the desired properties along the length of the extrudate.

The varied the percent by weight, fiber length or type of fiber across the part, the methods listed above are used in conjunction with a multiple-pass program to create the “log” or to deposit the extrudate onto the mold half.

A further result of the above alternatives can be thickness reduction across the component or in localized areas. Using this variation of the extrusion deposition compression molding process, components can be produced that have optimal physical properties across the part. Structural components can have varying percent of fiber reinforcement or length or type of fiber as indicated. Aesthetic/clad interior panels can have fiber reinforcement in isolated areas to meet specific component requirements.

Utilizing the variations of the fiber reinforcement process, components that have optimal physical properties across the component can be produced. Structural components can have varying percent fiber reinforcement or varying length or type of fiber. The aesthetic interior body parts or panels can have fiber reinforcement in isolated areas to meet specific component requirements without the costly waste of generalized fiber reinforcement. In addition to the cost reduction the component weight can also be reduced without loss of strength. The use of the optimally reinforced thermoplastic component process provides the ability to locate reinforcement within the component which can lead to overall thinner components.

As an alternative, and in applications where multiple component parts having the same structural requirements are being molded, a computer algorithm is employed to control the feeders and the plastication/injection units (e.g. amount of extrudate, percentage of fiber, type of fiber, distribution locations etc.).

In accordance with an exemplary embodiment of the present invention, an optimally reinforced thermoplastic component is capable of being produced by reducing the cost and component weight by minimizing the amount of fiber material being used. The ability to optimally locate reinforcement within the component leads to an overall thinner or localized thinner component design further reducing the amount of thermoplastic material being used and further reducing the cost and weight of the article been manufactured.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A method of making a reinforced component, comprising:
depositing a polymer into an extrusion deposition unit;
depositing a fiber into said extrusion deposition unit;
varying said fiber deposited into said extrusion depostion unit; and
depositing an extrudate onto a mold core or cavity; said extrudate having varying fiber reinforcement.

2. The method of making a reinforced component as in claim 1, wherein said depositing said extrudate is done using an extrusion deposit compression molding process.

3. The method of making a reinforced component as in claim 1, wherein varying said fiber comprises varying the percent by weight of said fiber.

4. The method of making a reinforced component as in claim 1, wherein varying said fiber comprises varying the length of said fiber.

5. The method of making a reinforced component as in claim 1, wherein varying said fiber comprises varying the type of fiber.

6. The method of making a reinforced component as in claim 1, wherein depositing said extrudate comprises depositing an extrudate log or other shape that is subsequently transferred onto a mold core or cavity.

7. The method of making a reinforced component as in claim 1, wherein depositing said extrudate comprises depositing said extrudate in layers onto said mold core or cavity.

8. The method of making a reinforced component as in claim 1, wherein depositing said extrudate comprises depositing said extrudate with multiple passes.

9. The method of making a reinforced component as in claim 1, wherein depositing said fiber in said extrusion deposition unit comprises multiple feed elements.

10. The method of making a reinforced component as in claim 1, further comprising varying reinforcement in said reinforced component comprising altering the amount of fiber fed into a plastication/injection unit and concurrently altering the amount of polymer fed into said plastication/injection unit, said amount of fiber been fed by a plurality of feeders been independently actuated.

11. The method of making a reinforced component as in claim 1, wherein varying the length of said fiber comprises actuating various feeder elements at various times to deposit various strands of fiber into said extrusion deposition unit.

12. The method of making a reinforced component as in claim 1, wherein varying fiber comprises actuating various said feeder elements at various times to deposit various fibers into said extrusion deposition unit.

13. A method of making a reinforce component, comprising:
depositing a thermoplastic material into an extrusion deposition unit;
depositing a fiber reinforcing material into said extrusion deposition unit;
varying the percentage by weight of said fiber reinforcing material deposited into said extrusion deposition unit; and
depositing an extrudate log onto a conveyor mechanism, said extrudate log having varying fiber reinforcement along its length.

14. A method of making a reinforced component comprising:
a means for depositing a polymer into an extrusion deposition unit;
a means for depositing a fiber into said extrusion deposition unit;
a means for varying said fiber deposited into said extrusion deposition unit; and
a means for depositing an extrudate into a mold cavity, said extrudate having varying fiber reinforcement.

15. A method of making a reinforced component comprising:
a means for depositing a polymer into an extrusion deposition unit;
a means for depositing a fiber into said extrusion deposition unit;
a means for varying said fiber deposited into said extrusion deposition unit; and
a means for depositing an extrudate log onto a conveyor; said extrudate log having varying fiber reinforcement.

16. The method as in claim 1, wherein said reinforced component is a cross car structural beam.

17. The method as in claim 7, wherein said extrudate is deposited into said mold core so as to vary the orientation of said fiber in each successive layer.

18. The method as in claim 13, further comprising:
determining areas of said reinforced component requiring fiber reinforcement.

19. The method as in claim 18, wherein said areas of said reinforced component requiring fiber reinforcement are determined through stress modeling techniques.

20. The method as in claim 19, further comprising:
varying the amount of said fiber reinforcement material in said extrudate log, said fiber reinforcement material being varied in accordance a computer algorithm.
